(19) United States
(12) Patent Application Publication
(10) Pub. No.: US 2007/0276969 A1
(43) Pub. Date: Nov. 29, 2007

(54) Method and device for controlling an access to peripherals

(76) Inventors: Philippe Bressy, Ollioules (FR); Gilles Perrotey, Gemenos (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/593,549

(22) PCT Filed: Mar. 17, 2005
(86) PCT No.: PCT/FR05/00648

§ 371 Date: Sep. 19, 2006

Related U.S. Application Data
(60) Provisional application No. 60/600,912, filed on Aug. 12, 2004.

(30) Foreign Application Priority Data
Mar. 19, 2004 (FR) 0402842

(51) Int. Cl. G06F 1/00

(52) U.S. Cl. 710/48

(57) ABSTRACT

This method of controlling access, by a processor to a peripheral of this processor, includes the following steps:
triggering (E34) a processor interrupt, termed control interrupt;
obtaining (E37), from the processor and following this triggering, an access authorisation code (Code-AA) to the peripheral;
comparing (E38) the access authorisation code (Code-AA) with a predetermined reference value (Code-UMCA);
generating (E50) an electrical signal validating a peripheral access signal, depending on the outcome of said comparison step (E30).

### BACKGROUND OF THE INVENTION

The present invention relates to the field of security of electronic devices, and more precisely that of protecting these devices against fraudulent manipulations and attacks on their integrity.

Two main types of attack are known, i.e. attacks of the software type on one hand and those involving the addition or substitution of hardware components on the other hand.

To counter software attacks, so-called high-level tools are known, i.e. tools that work above the layers of the operating system (antivirus, firewall, etc.).

Unfortunately these tools, albeit powerful, have a serious weakness in that they can be deactivated or bypassed before they are loaded into memory.

A consortium named Trusted Computing Group (TCG) aims to overcome this drawback by providing tools and methods of protecting the low-level software layers, and also for identifying physical peripherals.

TCG proposes in particular a method of checking the authenticity of the BIOS (Basic Input Output System) of a personal computer before it is loaded.

To this end, such a method uses a CRTM trust code (Core Root of Trust Measurement), this CRTM code being executed when the computer is switched on to compute a BIOS signature.

This CRTM trust code thus constitutes the basis of any software security sequence in the system, and must also therefore itself be protected against attacks.

To safeguard this CRTM code, provision is conventionally made to implement the code in a specific sector of a flash type memory installed on the motherboard of the system.

The drawback of such a solution is that modification of this CRTM trust code, for upgrading purposes for example, is impossible without physical intervention on the motherboard, as described in the IBM document US 2003/0135727 published on 17 Jul. 2003.

This document proposes a first solution to this problem which consists in implementing the trust code (CRTM) in a motherboard add-on card (feature card), this feature card having its own BIOS. Upgrades can then be effected simply by physical replacement of this feature card.

While this solution is acceptable within the framework of the specifications developed by TCG, it will be understood that it is not at all acceptable when it is desired to extend boot loader and BIOS protection to the second type of attack, namely hardware attacks, by a user or a third party (games console, IMEI code and SIM lock of GSM devices in particular).

This solution thus poses a major drawback for this extended protection case, since all that is required in order to deactivate all of the system security functions is to remove this feature card.

The TCG consortium has also addressed the problem of the hardware integrity of computers (PCs) by controlling the peripherals used. More precisely, the consortium specifies the use of a TPM module which registers the names and locations of the peripherals of a computer in order to generate an alarm if a peripheral, for example a hard disk, has been replaced between two boot sequences. This involves checking the identity of a peripheral.

In a similar manner and in the context of games consoles, document WO 43716 (3DO) describes a method of authenticating a peripheral (a games cassette), by a processor (that of the console) to combat illegal copying of the cassette.

The 3DO document proposes to incorporate a secret key into the cassette, which will be verified by the console which also holds this key. To prevent the substitution of a duly authenticated cassette by a pirate cassette, 3DO additionally proposes the use of a mechanism for exchanging security data between the cassette and the console throughout the game. The console thus checks that it is always talking to the same cassette.

Unfortunately this solution requires that a secret key and a dedicated program with a secret security algorithm be embedded and hidden in the peripheral (the cassette). This constraint is a brake on the development of this type of technology.

### OBJECT AND SUMMARY OF THE INVENTION

The invention makes it possible to overcome the aforementioned drawbacks.

To this end, the Applicant has chosen a very different approach which is based neither on an identification mechanism nor on an authentication mechanism.

More precisely, and according to a first aspect, the invention relates to a hardware unit to control access, by a processor, to a peripheral of this processor, this hardware unit including:
means of triggering a processor interrupt, termed control interrupt;
means of obtaining, from the processor and following triggering of the interrupt, a code authorising access to the peripheral;
means of comparing this access authorisation code with a predetermined reference value; and
so-called validation means designed to generate an electrical signal validating an electrical signal for access to the peripheral depending on the outcome of said comparison.

Thus, the mechanism according to the invention is based on the issue, by the processor, of access authorisation codes monitored by a hardware unit placed ahead of the peripheral, for bus disconnection.

In a highly advantageous manner, the access authorisation code is received by the access control hardware unit, after the latter has made an explicit request to the processor to obtain this code, in the form of an interrupt directed to the processor. The hardware unit thus knows for certain that the access authorisation code has been supplied to it by the processor.

This feature makes it possible to achieve highly effective control of access to the peripheral as it ensures that the access authorisation code is received for certain from a component of trust constituted by the control interrupt routine.

In other words, the invention is based on the use of a software component (computer program) which constitutes a single point of access to the peripheral, and which in cooperation with and via the access control hardware unit monitors the electrical signal to access the peripheral.

This software component preferably resides in a secure and controlled region of the processor.

The invention thus makes it possible to control access to the peripheral of a processor by validating at the lowest level, by hardware means, the electrical signal accessing this peripheral. The peripheral can in particular be selected from a screen, a keyboard, a memory, a communications interface controller, a memory management unit (MMU) or a memory protection unit (MPU).

When the invention is used to control write access to the flash memory holding the startup code (boot loader), it allows this startup code to be updated without physical intervention, while at the same time protecting the code against fraudulent manipulations.

In the remainder of this document, the term “peripheral” will be used in reference to any type of electronic component (screen, keyboard, memory, communications interface, smart card interface, MMU, MPU, etc.), whether they are discrete components or “integrated” into FPGAs or ASICs.

Similarly, the expression “access electrical signal” will be used in reference to any electrical signal that has to be activated to select the peripheral (ChipSelect (CS) type signal) or to write to the peripheral (WRITE-ENABLE (WE) type signal).

Similarly, the term “interrupt” will be used in reference to any means designed to suspend the execution of software, asynchronously or otherwise.

In order to considerably strengthen the security of the system, the control interrupt is a non-maskable interrupt, which means that it is not possible to mask the aforementioned suspension.

The person skilled in the art will appreciate that depending on the chosen architecture, different types of signals may be used for this purpose, and in particular:
NMI signal for the INTEL x86 family architecture;
IPL<7> level for the MOTOROLA 68K family architecture;
address or data error cycles associated with the /BERR signal in the MC68K architecture;
ABORT exceptions in the ARM7TDMI architecture.

According to the present invention, the peripheral thus protected can only be accessed on presentation to the hardware unit controlling access to said peripheral of an access authorisation code compatible with the known predetermined reference value of the hardware unit.

The invention thus makes it possible in particular to protect a so-called secure memory, such as for example that contained in a GSM-compliant mobile telephone for storage of the commercial terms of subscription with an operator (SIM Lock).

Fraudulent substitution of these SIM-Lock rules is only then possible upon presentation of a valid access authorisation code to the hardware unit controlling access to this memory.

The invention can also be used to upgrade the BIOS or the operating system of a device, remotely. Portable telephones will therefore be readily upgradeable, directly via the GSM wireless link, without the customer having to visit an upgrade centre.

The invention can thus be used to prevent any fraudulent modification of the BIOS of a PC, thereby considerably enhancing the security of the PC, in particular when the BIOS contains higher level security mechanisms.

Preferably, the controlling hardware unit additionally includes means of obtaining a trigger code, and the means of triggering the control interrupt are designed to trigger the interrupt once the trigger code has been obtained.

This trigger code can for example be sent by the processor before any access to the peripheral. A fully closed-loop mechanism is thus placed between the processor and the hardware unit which means that the access control hardware unit systematically requests an access authorisation code from the processor before validating the access signal.

Preferably, the access control hardware unit includes means of comparing this trigger code with the predetermined reference value, said triggering means being designed to trigger the control interrupt as a function of the outcome of said comparison.

Thus, on presentation of an erroneous trigger code, another process can be put in place, as described below.

Thus, in an alternative embodiment, the access control hardware unit according to the invention includes means of triggering a processor interrupt, referred to as an alarm interrupt, when said access authorisation code or said trigger code is different from the predetermined reference value. This alarm interrupt is preferably a non-maskable interrupt.

In a first alternative embodiment, the predetermined reference value is a constant.

The control interrupt routine can thus authorise access to the peripheral by simply sending the constant to the controlling hardware unit. This variant is particularly simple to put into effect.

In a second alternative embodiment, the access control hardware unit according to the invention includes means of generating the aforementioned reference value according to a predetermined law.

Advantageously, this feature serves to strengthen the control of access to the peripheral in that the pirate will also need to know the predetermined law in order to be able to present a valid access authorisation code to the access control hardware unit.

In a preferred mode of this second alternative embodiment, the predetermined reference value is a counter initialised when the hardware unit is switched on, and the predetermined law involves incrementing this counter every time an access authorisation code is obtained.

This predetermined law can be implemented in particular by a counter associated with a finite state controller, which avoids the more costly use of a (co-)processor, and limits the overall manufacturing cost of the hardware unit.

According to another advantageous feature, the validation means of the hardware unit controlling access to the peripheral include logic combination means designed to:
receive an electrical signal requesting access to the peripheral;
receive the validation signal; and
validate the access electrical signal as a function of a state of the access request electrical signal, a state of the validation signal, and a logic represented in a truth table.

According to this feature, access to the peripheral is thus validated when two conditions are met, namely on one hand the presence of a request for access to the peripheral by a third component, for example a processor, and on the other hand when the outcome of the aforementioned comparisons represents the acquisition of a valid access authorisation code by the controlling hardware unit.

Preferably, the access signal results from the “logical AND” combination between the access request signal and the validation signal. This embodiment is particularly easy to put into effect.

In a preferred embodiment, the access control hardware unit according to the invention includes means of reading a state of the access request electrical signal, and means of triggering an alarm interrupt, preferably non maskable, as a function of this state and the state of the access validation electrical signal.

This feature advantageously enables this alarm interrupt to be triggered when the state of the access request electrical signal represents a request for access to the peripheral, without an access authorisation code having been presented to the access control hardware unit.

In a preferred embodiment, the access control hardware unit according to the invention includes means of inhibiting the validation signal, this inhibition preferably being effected after one or more accesses to the peripheral.

Advantageously this feature makes it possible to strengthen the control of access to the peripheral, in that it must be performed regularly, and even before each access to the peripheral.

In another embodiment, inhibition of the validation signal is effected after a predetermined delay counted from the generation of the access validation electrical signal, or from the acquisition of the access code.

Advantageously this feature makes it possible to authorise access to the peripheral without control during this delay, which improves the overall performance of the system. This feature is particularly useful when the volume of data exchanged with the peripheral is large, as in the case of a screen.

Correlatively, the invention relates to a method of controlling access, by a processor, to a peripheral of this processor. This method includes the following steps:
triggering a processor interrupt, termed control interrupt, preferably non-maskable;
obtaining, from the processor and after said triggering, a code authorising access to the peripheral;
comparing the access authorisation code with a predetermined reference value;
generating an electrical signal validating a peripheral access signal, as a function of the outcome of said comparison step.

Given that the particular advantages and features of this access control method are the same as those described previously in reference to the controlling hardware unit, they will not be restated here. This method essentially involves checking the validity of one or more access authorisation codes, necessarily received from a component of trust, by comparing it to predetermined reference values (constant or generated according to a law), and validating a peripheral access electrical signal as a function of this comparison.

According to another aspect, the invention relates to a processor including an access control hardware unit as briefly described above. This processor also includes:
means of implementing a control interrupt routine designed to obtain the access authorisation code; and
means of sending this access authorisation code to the access control hardware unit.

In this preferred embodiment of the invention, the access control hardware unit described previously is embedded within a processor, this processor including means of sending to the controlling hardware unit the code authorising access to a given peripheral.

This preferred embodiment of the invention considerably strengthens access control to the peripheral in that it then becomes impossible to physically bypass, or in other words to shunt, the access control hardware unit.

Preferably, the processor according to the invention includes the peripheral to which access is thereby protected.

This peripheral can in particular be a memory management unit.

The invention can thus protect access to the memory management unit (MMU). This makes it possible to create two completely sealed system environments on the same processor. If in addition a space is provided for controlled data exchanges between these two environments, the person skilled in the art will appreciate that it is a simple matter to construct devices wherein certain functions (operating system or sensitive applications such as payment, authentication, copyright protection and copy protection applications) are isolated from applications that are more open and therefore more vulnerable to attacks (Internet browser, games, video, email, etc.).

The peripheral contained in the processor according to the invention can also be a write controller for the processor boot memory.

This preferred embodiment thus ensures the security of the processor boot memory, this protection making it impossible to fraudulently modify the data contained in this memory, this being a region where security is highly critical in that it often handles higher-level security procedure calls.

Correlatively, the invention relates to a method of managing access to a peripheral. This management method includes a step of running a routine associated with a control interrupt, preferably non-maskable. This control routine includes a step of sending an access authorisation code to an access control hardware unit as described briefly above.

In a first alternative embodiment, the access control code is a constant, read from a protected memory.

In a second alternative embodiment, the access management method additionally includes a step of generating an access authorisation code according to a predetermined law.

The person skilled in the art will readily appreciate that it is preferable, in this first alternative embodiment, to mask all of the interruptions, without which an illicit access to the peripheral could be effected by a malicious interrupt during the time interval between reading the constant from the protected memory and triggering of the non-maskable control interrupt routine.

Given that the particular advantages and features of this access management method are the same as those described briefly above in reference to the processor according to the invention, they are not restated here. This method essentially consists in providing, from a component of trust (i.e. the processor implementing the control interrupt routine), access authorisation codes, these codes being compared by the controlling hardware unit with predetermined reference values (constant or generated according to a law) to authorise or deny access to the peripheral.

The invention also discloses a computer program including an instruction to access a peripheral and an instruction to send a trigger code to a hardware unit controlling access to this peripheral as described briefly above, prior to the execution of this access instruction.

Preferably, this computer program additionally includes means of generating the trigger code according to the predetermined law for generation of the access authorisation code.

This computer program constitutes a single point of access to the peripheral, preferably residing in a secure and controlled region of the processor. This program controls, in cooperation with the hardware unit, the electrical signal to access this peripheral.

The invention also discloses a processor designed to implement an access control method, an access management method, and/or a computer program such as described briefly above.

### BRIEF DESCRIPTION OF THE DRAWINGS

Other aspects and advantages of the present invention will become more clearly apparent on reading the particular embodiment described below, this description being provided only by way of a non-limitative example and made in reference to the attached drawings in which:

FIG. 1 illustrates a processor according to the invention in a first embodiment;

FIG. 2 illustrates a processor according to the invention in a second embodiment;

FIG. 3 illustrates an access control hardware unit according to the invention in a preferred embodiment;

FIGS. 4a and 4b illustrate, in the form of control charts, the principal steps of the access control methods according to the invention;

FIG. 5 illustrates, in the form of a block diagram, the principal steps of a control interrupt routine according to the invention in a preferred embodiment; and

FIG. 6 illustrates, in the form of a block diagram, the principal steps of a program accessing a protected peripheral, according to the present invention.

### DETAILED DESCRIPTION OF SEVERAL EMBODIMENTS

The embodiment of the invention described here relates more particularly to the protection of access to a boot memory contained in a processor.

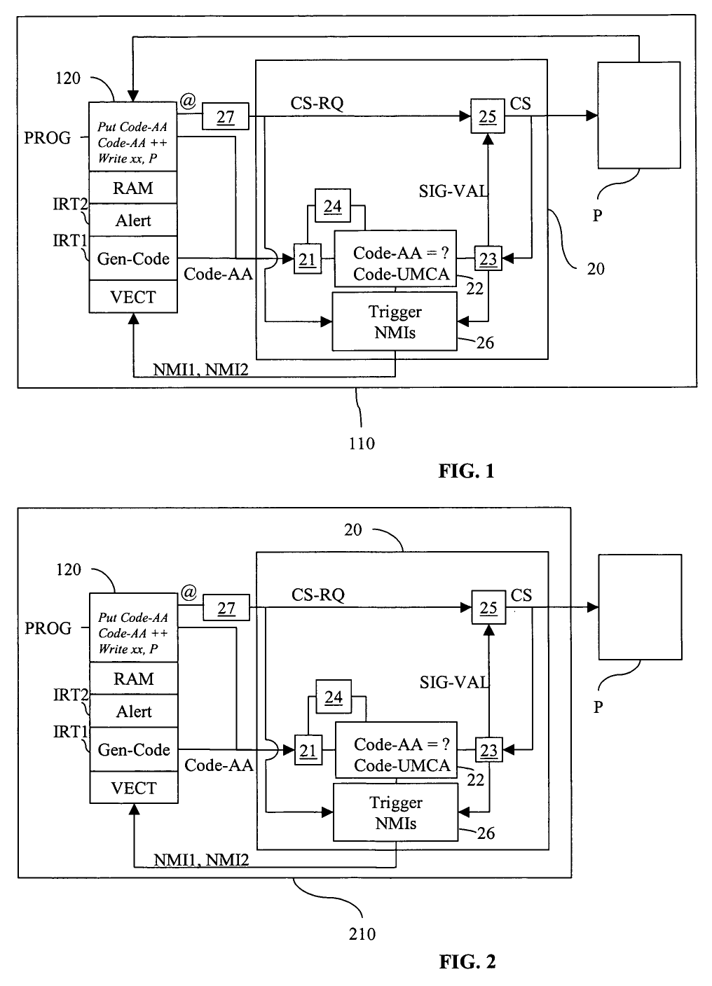

FIG. 1 depicts a processor 110 according the invention in a preferred embodiment.

The processor 110 includes a boot memory 120 (BOOT-ROM) and a protected volatile memory (RAM). This boot memory 120 includes an interrupt vector table VECT, two interrupt routines, respectively control IRT1 and alarm IRT2, and a computer program PROG.

This computer program PROG is a control program for a peripheral P internal to the processor, such a program normally being referred to as a “driver”.

In the preferred embodiment described here, the peripheral P internal to the processor is a write controller for the abovementioned boot memory 120.

The processor 110 includes a hardware unit 20 controlling access to the peripheral P, according to the present invention.

This access control hardware unit 20 includes means of obtaining a trigger code Code-DD and an authorisation code Code-AA for access to the peripheral P.

In the embodiment described here, the trigger code Code-DD and the access authorisation code Code-AA are obtained from the same register 21.

In the preferred embodiment described here:
the access authorisation code Code-AA is written to the register 21 by the control interrupt routine IRT1; and
the trigger code Code-DD is written to the register 21 by the driver PROG of the peripheral P.

Thus, according to the invention, before each instruction (WRITE, READ, etc.) to access the peripheral P, the computer program PROG writes a trigger code Code-DD to the register 21 of the hardware unit 20.

In the embodiment described here, the trigger code Code-DD and the access authorisation code Code-AA are two successive values of the same variable calculated according to the predetermined incrementation law.

This variable is stored in a protected area of the volatile RAM memory of the processor. This memory is only accessible to the computer program PROG and to the control interrupt routine IRT1.

The access control hardware unit 20 also includes means 24 designed to generate, according to a predetermined law, a reference value Code-UMCA when an authorisation code Code-AA or a trigger code Code-DD is written to the register 21.

In the preferred embodiment described here, this law involves incrementing the Code-UMCA counter, the latter being initialised when the processor 110 is switched on.

The access control hardware unit 20 also includes means 22 of comparing the access authorisation code Code-AA (and the trigger code Code-DD) obtained from the register 21 with the predetermined reference value Code-UMCA, calculated by the means 24 of generating this value.

In the preferred embodiment described here, these comparison means 22 are constituted by wired logic.

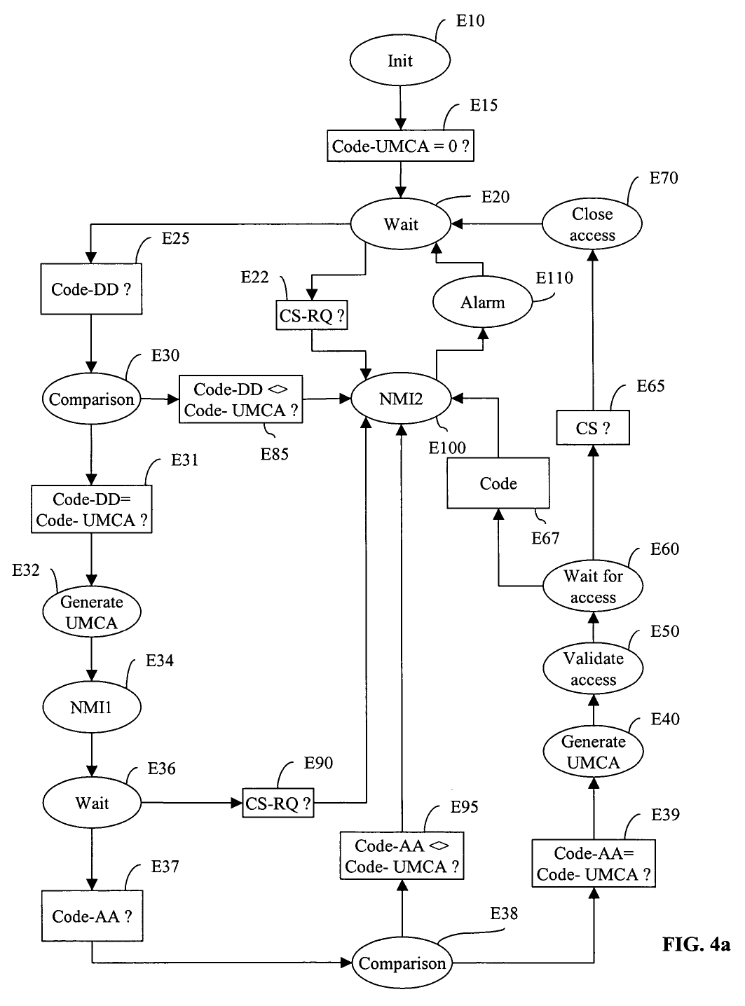

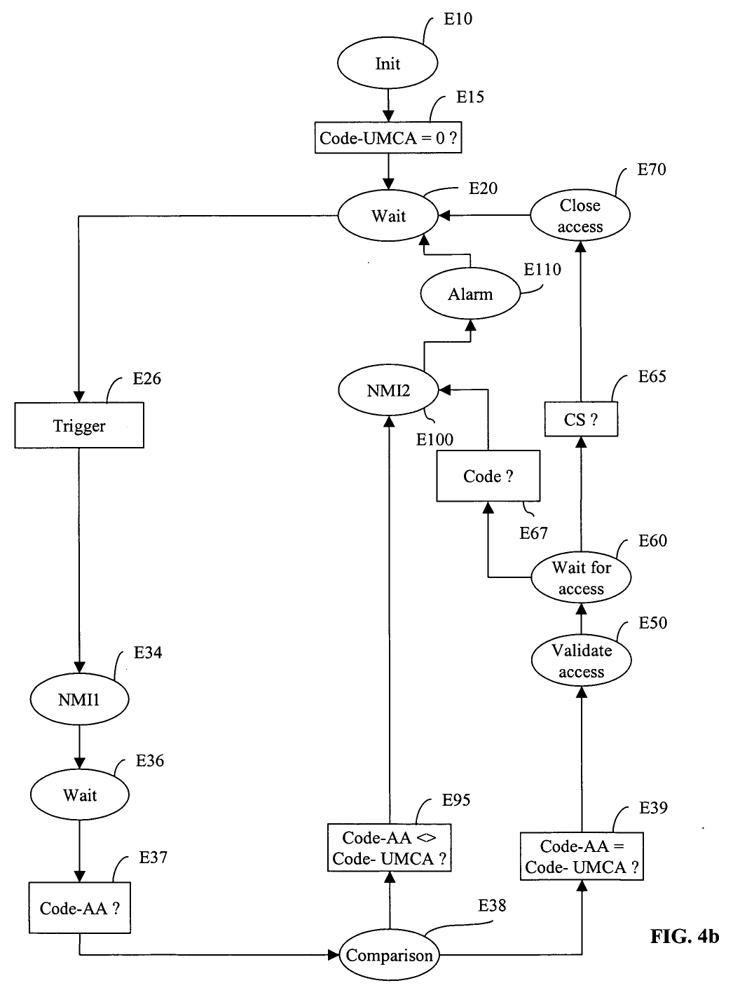

As the case may be, these comparison means 22 are designed to send a first signal to an interrupt triggering unit 26, when the trigger code Code-DD is found equal to the current value of the reference code Code-UMCA. This will be described later in reference to FIG. 4a.

On receiving this first signal, the interrupt triggering means 26 generate an interrupt signal. In the example described here, this interrupt signal is a non-maskable interrupt signal NMI1.

On receiving this non-maskable interrupt signal NMI1, the processor executes, by means of the interrupt vector table VECT, the control interrupt routine IRT1.

This control interrupt routine IRT1 implements a computing function Gen-Code designed to compute a new value of the access authorisation code Code-AA according to a predetermined law, to store this new value in the protected memory, and to write this new Code-AA value to the register 21 of the access control hardware unit 20.

This predetermined law is identical to that implemented by the means 24 of generating the reference value Code-UMCA. Thus, in the preferred embodiment described here, this law is an incrementation law and the access authorisation code Code-AA is equal to the value of the trigger code Code-DD plus one.

When the means 21 of obtaining the access authorisation code Code-AA receive this authorisation code Code-AA from the control interrupt routine IRT1, the means 24 of generating a reference value Code-UMCA generate a new reference value according to the predetermined incrementation law.

These two new values are then compared by the comparison means 22 previously described.

According to the invention, the comparison means 22 are designed to set a value representing the result of the comparison of these two new values in a flip-flop 23 of the access control hardware unit 20.

In the embodiment described here, we will assume that the wired logic 22 sets the value 1 in the flip-flop 23 when the new access authorisation code Code-AA and the new predetermined reference value Code-UMCA are equal.

Thus, in the preferred embodiment described here, the content of the flip-flop 23 is set to 1 when the trigger code Code-DD and authorisation code Code-AA received successively from the driver PROG and from the control interrupt routine IRT1 are equal to the two predetermined reference values Code-UMCA generated by the means 24 on receiving the codes.

According to this preferred embodiment, when the flip-flop 23 is set to 1, the latter generates a validation electrical signal SIG-VAL for transmission to the logic combination means 25 of the access control hardware unit 20.

Thus, in this preferred embodiment, the validation signal SIG-VAL is generated when the foregoing two conditions are satisfied.

Before transmitting the trigger code Code-DD to the access control hardware unit 20, the driver PROG generates a new value according to the predetermined law, i.e. increments it in the embodiment described here, and stores this new value in the protected volatile RAM memory.

The driver of the peripheral P then executes an instruction to access the peripheral P.

In a manner known to the person skilled in the art, this instruction generates, at the output of an address decoder 27, an access electrical signal, of the Chip-Select (CS) type, for transmission to the peripheral P.

According to the present invention, this access signal is not transmitted directly to the peripheral P, but is delivered to the input of the aforementioned logic combination means 25.

In the remainder of this document, this signal will be referred to as an access request electrical signal CS-RQ.

The logic combination means 25 which receive at their input, on one hand, the electrical signal CS-RQ requesting access to the peripheral P and the validation signal SIG-VAL on the other hand, also include a truth table designed, in a known manner, to generate an access signal of the chip-select (CS) type, for transmission to the peripheral P.

In other words, for the purposes of the present invention, the truth table 25 facilitates validation of the electrical signal to access the peripheral P.

In the preferred embodiment described here, the access signal CS at the output of the logic combination means 25 is delivered to the input of the flip-flop 23.

In this embodiment, when an access to the peripheral P is made, i.e. when the state of the access signal CS is high, the value of the flip-flop 23 is reset to 0.

This has the effect of inhibiting the validation signal SIG-VAL at the output of this same flip-flop 23, and therefore of invalidating any access to the peripheral P.

In another embodiment, the validation signal SIG-VAL is inhibited in a cyclical manner, for example every five accesses, rather than at each access to the peripheral P.

In another preferred embodiment, the access signal CS is not fed back to the flip-flop 23, the latter being designed to automatically inhibit the validation signal SIG-VAL after a predetermined delay counted from the generation of this same signal, or from the acquisition of the trigger code Code-DD.

In the preferred embodiment described here, the comparison means 22 are designed to send a second signal to the interrupt triggering unit 26 when it detects, by comparison, that a code obtained from the register 21 is different from the predetermined reference value Code-UMCA generated on receipt of this code.

On receiving this second signal, the interrupt triggering means 26 send a second interrupt signal to the boot memory 120. In the embodiment described here, this is a non-maskable interrupt signal NMI2.

Thus, if a hostile program writes a random code in the register 21, the comparison means 22 will trigger a non-maskable interrupt NMI2.

On receiving this second interrupt signal, the processor executes the alarm interrupt routine IRT2 for the handling of fraudulent accesses to the peripheral P.

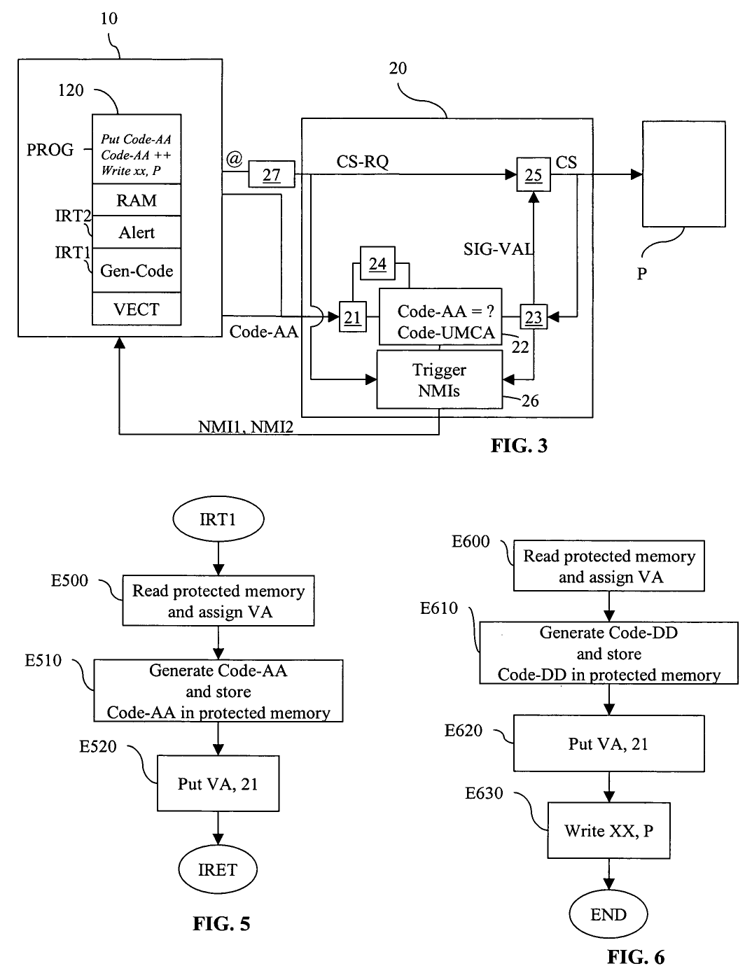

FIG. 2 illustrates another processor 210 according to the present invention in another embodiment.

The only difference between this processor 210 and the processor 110 described previously in reference to FIG. 1, is that the processor 210 is used to control access to an external peripheral P.

Given that all of the other features are identical, it will not be described further here.

FIG. 3 illustrates an access control hardware unit 20, in the form of a component external to a processor 10.

In this embodiment of the invention, the processor 10 cooperating with the access control hardware unit 20, includes a boot memory 120 identical to that described previously in reference to the processor 110 in FIG. 1.

The access control hardware unit 20 in this figure is identical to that described previously in reference to FIG. 1 and will not be detailed below.

FIG. 4a illustrates, in the form of a finite state controller, the principal steps of an access control method according to the invention in a preferred embodiment.

In this figure, the “bubbles” represent states, arrows represent transitions, and the rectangles represent necessary and sufficient conditions for implementation of the transitions.

In the remainder of the description, the terms “step” or “state”, known to the person skilled in the art of computer programs, will be used interchangeably.

This controller includes a first initialisation state E10, which is exited (transition E15) when the predetermined reference value Code-UMCA is initialised with an initial value, for example zero, then stored in the volatile RAM memory.

A waiting state E20 is then entered.

When, in this waiting state E20, the access control hardware unit receives a trigger code Code-DD (transition E25), a state E30 is entered wherein this trigger code Code-DD is compared with the predetermined reference value Code-UMCA.

However, when in this waiting state E20 an access request electrical signal CS-RQ is detected at the peripheral P (transition E22), a state E100 is entered wherein a non-maskable alarm interrupt NMI2 is triggered.

This state E100 of triggering a non-maskable alarm interrupt NMI2 is automatically exited and an alarm management state E110 is then entered.

In a preferred embodiment, the alarm management state E110 causes a terminal code to be executed (generation of a RESET condition). In other embodiments, various reactions can be envisaged depending on the application. These embodiments are not the object of this patent and will not be detailed here.

Once this alarm management procedure is complete, the alarm can be cancelled and the waiting state E20 described previously can be resumed.

When from the comparison state E30 it is determined that the trigger code Code-DD is different from the predetermined reference value Code-UMCA (transition E85), the state E100 is entered wherein a non-maskable alarm interrupt NMI2 previously described is triggered.

However, when from the comparison state E30 it is determined that the value of the trigger code Code-DD is equal to the predetermined reference value Code-UMCA (transition E31), a state E32 is entered wherein a new predetermined reference value Code-UMCA is generated in accordance with the predetermined incrementation law.

This state E32 wherein a new reference value Code-UMCA is generated is followed by a state E34 wherein a non-maskable control interrupt NMI1 is triggered.

Once this non-maskable control interrupt NMI1 is triggered, a waiting state E36 is entered wherein an access authorisation code Code-AA is awaited.

If in this state E36 of waiting for an access authorisation code AA, an access request electrical signal CS-RQ is detected (transition E90), the state E100 is entered wherein a non-maskable alarm interrupt NMI2 is triggered.

However, when in the waiting state E36 an access authorisation code Code-AA is obtained (transition E37), a state E38 is entered wherein this access authorisation code Code-AA is compared with a new current reference value Code-UMCA.

If during this comparison state E38 it is determined that the access authorisation code Code-AA is different from the reference value Code-UMCA (transition E95), state E100 is entered wherein a non-maskable alarm interrupt NMI2 is triggered.

However, if these two values are equal (transition E39), the comparison state E38 is exited and a state E40 is then entered wherein a new reference value Code-UMCA is generated.

This generation state E40 is automatically exited and a state E50 is then entered wherein an electrical signal SIG-VAL is generated to validate the access signal to the peripheral P.

This state E50 wherein the validation electrical signal SIG-VAL is generated is then automatically exited and a waiting state E60 is entered until access to the peripheral P has actually taken place.

When in this waiting state E60 it is detected that access has actually taken place (transition E65), a state E70 is entered wherein the validation signal SIG-VAL is inhibited.

This inhibition state E70 is then automatically exited and the previously described waiting state E20 is resumed.

In another embodiment, when in the waiting state E60 the acquisition of a code from the register 21 is detected (transition E67), the state E100 is entered wherein a non-maskable alarm interrupt NMI2 is triggered, this access authorisation code having necessarily been sent to the access control hardware unit by an ill-intentioned third party. This embodiment serves to strengthen the security of the system by detecting fraudulent accesses to the peripheral after validation of the access (state E60).

FIG. 4b depicts a diagram of state of an access control method according to the invention in a second embodiment.

This embodiment of the invention is simplified in the sense that it does not include step E25 of receiving a trigger code Code-DD. Of course any step (E30, E31, E32, E85) of handling this trigger code Code-DD is eliminated.

Step E25 is replaced by a triggering step E26, the latter being implemented by any means known to the person skilled in the art and capable of generating an interrupt.

Triggering step E26 is automatically followed by step E34 wherein a non-maskable control interrupt NMI1 described in reference to FIG. 4a is generated.

In this embodiment, the authorisation code Code-AA being a constant, the step E40 of generating a reference value Code-UMCA is eliminated.

The control interrupt routine IRT1 presents in the register 21 the value stored by the computer program PROG in the protected memory.

FIG. 5 illustrates the principal steps E500 to E520 of a non-maskable control interrupt routine IRT1 implemented by a processor according to the invention in a preferred embodiment.

This routine is activated when the access control hardware unit 20 generates a non-maskable control interrupt NMI1.

The routine IRT1 described here includes a first step E500 during which the content of a variable Code-AA including the access authorisation code of the same name is stored in a variable VA.

In the embodiment described in reference to FIG. 4a the step E500 of reading the access authorisation code Code-AA is followed by a step E510 during which a new access authorisation code Code-AA is generated according to the predetermined law described previously. During this same step, this new value of the access authorisation code Code-AA is stored in the protected memory.

The step E510 of generating and storing the new access authorisation code Code-AA is followed by a step E520 of sending the contents of the variable VA to the access control hardware unit 20.

In the preferred embodiment described here, this sending step consists in writing the contents of the variable VA to the register 21.

In the embodiment described in reference to FIG. 4b, the step E500 of reading the access authorisation code Code-AA is followed by this step E520.

As the case may be, the step E520 of sending the access authorisation code is followed by an instruction of the type IRET known to the person skilled in the art, which involves on one hand cancelling the source of the interrupt NMI1 and returning from said interrupt.

The access management method according to the invention optionally includes an alarm interrupt routine IRT2 in response to a non-maskable interrupt NMI2 originating from the access control hardware unit 20.

This non-maskable alarm interrupt consists essentially in generating an alert and/or handling the unauthorised access according to suitable rules.

FIG. 6 illustrates the principal steps E600 to E630 of a computer program PROG including instructions for accessing a secure peripheral P according to the invention, in the embodiment of FIG. 4a.

This computer program includes two steps E600 and E610 identical or similar respectively to steps E500 of reading the access authorisation code, and E510 of generating and storing an access authorisation code described previously in reference to FIG. 5.

Thus, during these two steps, the computer program P [sic] stores the contents of the current trigger code Code-DD in a variable VA, generates a new trigger code Code-DD according to the predetermined law (incrementation law), and stores this new value in the secure memory shared with the interrupt routine IRT1.

Before each step E630 of accessing the peripheral P, the computer program PROG includes a step E620 during which the contents of the variable VA are sent to the access control hardware unit 20, which in the embodiment described here involves writing the contents of this variable to the register 21.

This step E620 of sending the access authorisation code VA to the access control hardware unit 20 is followed by the step E630 of accessing the peripheral P.

In an implementation of the invention according to the embodiment in FIG. 4b, the computer program PROG includes a step E610′ of storing a constant value in the protected memory of the processor, then a step E620′ of triggering the first non-maskable control interrupt IRT1, before the step E630 of accessing the peripheral.

After the access, any different value of said constant is stored in the protected memory of the processor.

This step can also be performed by the control interrupt routine IRT1.

1-44. (canceled)

45. Hardware unit for controlling access, by a processor to a peripheral (P) of this processor, said hardware unit including:
means of triggering an interrupt of said processor, termed a control interrupt;
means of obtaining, from said processor and after said triggering, an access authorisation code (Code-AA) to said peripheral (P);
internal means of comparing said access authorisation code (Code-AA) with a predetermined reference value (Code-UMCA); and
so-called validation means designed to generate an electrical signal (SIG_VAL) to validate an access electrical signal (CS, WE, PWR) to said peripheral (P), depending on the outcome of said comparison, wherein said hardware unit is external to processor and in that it includes means of generating said reference value (Code-UMCA) according to a predetermined law.

46. Access control hardware unit according to claim 45, wherein said control interrupt is a non-maskable interrupt (NMI1).

47. Control hardware unit according to claim 45, wherein it additionally includes means of obtaining a trigger code (Code-DD), and in that said means of triggering said control interrupt (NMI1) are designed to trigger said interrupt following the acquisition of said trigger code (Code-DD).

48. Access control hardware unit according to claim 47, wherein it additionally includes means of comparing said trigger code (Code-DD) with said predetermined reference value (Code-UMCA), and in that said triggering means are designed to trigger said control interrupt (NMI1) depending on the outcome of said comparison.

49. Access control hardware unit according to claim 45, wherein it includes means of triggering an interrupt of said processor, termed an alarm interrupt, when said access authorisation code (Code-AA) or said trigger code (Code-DD) is different from the predetermined reference value (Code-UMCA).

50. Access control hardware unit according to claim 49, wherein said alarm interrupt is a non-maskable interrupt (NMI2).

51. Access control hardware unit according to claim 45, wherein said predetermined reference value (Code-UMCA) is a counter initialised when said hardware unit is switched on (UMCA), and in that, according to said predetermined law, said counter is incremented each time said access authorisation code (Code-AA) is obtained.

52. Access control hardware unit according to claim 45, wherein said validation means include logic combination means designed to:
receive an electrical signal requesting access (CS-RQ, WE-RQ) to said peripheral (P);
receive said validation signal (SIG_VAL); and
validate said access electrical signal (CS, WE) as a function of a state (RQ_0, RQ_1) of said access request electrical signal (CS-RQ, WE-RQ), a state (VAL_0, VAL_1) of said validation signal, and a logic represented in a truth table.

53. Access control hardware unit according to claim 52, comprising means of reading a state (RQ_0, RQ_1) of said access request electrical signal (CS_RQ, WE_RQ), and means of triggering an interrupt of said processor, termed an alarm interrupt (NMI2), preferably non-maskable, as a function of this state (RQ_0, RQ_1) and of said state (VAL_0, VAL_1) of said access validation electrical signal (SIG_VAL).

54. Access control hardware unit according to claim 45, wherein it includes means of inhibiting said validation signal (SIG_VAL).

55. Access control hardware unit according to claim 54, wherein said inhibiting means are designed to inhibit said validation signal (SIG_VAL) following at least one access to said peripheral (P).

56. Access control hardware unit according to claim 54, wherein said inhibiting means are designed to inhibit said validation signal (SIG_VAL) after a predetermined delay counted from the generation of said access validation electrical signal (SIG_VAL), or from the acquisition of said access code (Code-AA).

57. Method of controlling access, by a processor to a peripheral (P) of this processor, wherein it includes the following steps:
triggering (E34) an interrupt of said processor, termed control interrupt;
obtaining (E37), from said processor and after said triggering, an access authorisation code (Code-AA) to said peripheral (P);
comparing (E38) said access authorisation code (Code-AA) with a predetermined reference value (Code-UMCA);
generating (E50) an electrical signal (SIG_VAL) validating an access signal (CS, WE, PWR) to said peripheral (P), depending on the outcome of said comparison step (E30), wherein said method is adapted to be executed by an hardware unit (20) according to claim 45, external to said processor and in that it additionally includes a step (E40) of generating said reference value (Code-UMCA) according to a predetermined law.

58. Access control method according to claim 57, wherein said control interrupt is a non-maskable interrupt (NMI1).

59. Access control method according to claim 57, wherein said triggering step (E34) is performed after a step of obtaining (E25) a trigger code (Code-DD).

60. Access control method according to claim 59, wherein it additionally includes a step (E30) of comparing the trigger code (Code-DD) with said predetermined reference value (Code-UMCA), and in that said triggering step (E34) is performed depending on the outcome of said comparison step (E30).

61. Access control method according to claim 57, wherein it includes a step (E100) of triggering an interrupt of said processor, termed an alarm interrupt, when said access authorisation code (Code-AA) or said trigger code (Code-DD) is different from the predetermined reference value (Code-UMCA).

62. Access control method according to claim 61, wherein said alarm interrupt is a non-maskable interrupt (NMI2).

63. Access control method according to claim 57, wherein said predetermined reference value (Code-UMCA) being a counter, it additionally includes a step (E10) of initialising said counter, said counter being incremented during said generation step (E40).

64. Access control method according to claim 57, wherein during said step (E50) of generating the validation signal:
the state (RQ_0, RQ_1) of an electrical signal (CS-RQ, WE-RQ) requesting access to said peripheral (P) is read;
the state (VAL_0, VAL_1) of said validation signal (SIG_VAL) is read; and
said access electrical signal (CS, WE) is validated as a function of said state (RQ_1) of said access request electrical signal (CS_RQ, WE_RQ), of said state (VAL_1) of the validation signal (SIG_VAL), and as a function of a logic rule.

65. Access control method according to claim 64, wherein it includes a step (E20, E36) of reading a state (RQ_0, RQ_1) of said access request electrical signal (CS_RQ, WE_RQ), and a step (E100) of triggering a maskable interrupt of said processor, termed an alarm interrupt, preferably non-maskable (NMI2), as a function of said state (RQ_0, RQ_1) and of said state (VAL_0, VAL_1) of said access validation electrical signal (SIG_VAL).

66. Access control method according to claim 57, wherein it includes a step (E70) of inhibiting said validation signal (SIG_VAL).

67. Access control method according to claim 66, wherein said inhibiting step (E70) is performed following at least one step (E65) of accessing said peripheral (P).

68. Access control method according to claim 66, wherein said inhibiting step is performed after a predetermined delay counted from said step (E50) of generating the validation signal (SIG_VAL) or from the step (E25) of obtaining said trigger code (Code-DD).

69. Method of managing access to a peripheral (P), wherein it includes a step of implementing a routine (IRT1) associated with a control interrupt, preferably non-maskable (NMI1), said control routine including:
a step (E510) of generating, according to a predetermined law, an access authorisation code (Code-AA) to said peripheral (P); and
a step (E520) of sending an access authorisation code (Code-AA) to an access control hardware unit according to claim 45.

70. Method of managing access according to claim 69, wherein said access authorisation code (Code-AA) being a counter, it additionally includes a step of initialising said counter (Code-AA), and in that said generation step (E510) consists in incrementing said counter (Code-AA) before each sending (S100) of this code (Code-AA) to said hardware unit.

71. Method of managing access according to claim 69, wherein it additionally includes a step of implementing an alarm interrupt routine (IRT2), said alarm routine including a step of generating an alert and/or inhibiting the use of said peripheral.

72. Computer program including an instruction (E630) to access a peripheral (P), wherein it includes an instruction (E620) to send a trigger code (Code-DD) to an access control hardware unit of said peripheral (P) according to claim 45, before the execution of said access instruction.

73. Computer program according to claim 72, wherein it additionally includes means of generating said trigger code (Code-DD) according to said predetermined law.

74. Processor designed to implement a method of managing access according to claim 69.

75. Use of an access control hardware unit (20) according to claim 45, to validate an access signal to a peripheral (P) which can in particular be selected from a screen, a keyboard, a memory, a communications interface controller, a memory management unit (MMU) or a memory protection unit (MPU).

76. Processor designed to implement a computer program 72 according to claim 72.
